(19) United States
(12) Patent Application Publication
(10) Pub. No.: US 2004/0005422 A1
(43) Pub. Date: Jan. 8, 2004

(54) Idaho spud sack

(76) Inventor: Candice L. Kahler, McCall, ID (US)

Correspondence Address: Candice L Kahler, 651 S 3rd Street, McCall, ID, 83638, US

(21) Appl. No.: 10/190,175

(22) Filed: Jul. 5, 2002

(51) Int. Cl. B32B 1/02

(52) U.S. Cl. 428/36.1

(57) ABSTRACT

The Idaho Spud Sack is a fabric “sack or bag” made from one hundred percent cotton fabric and lined with a polyester batting, that is used to cook “just right” baked potatoes in the microwave oven in ten to fifteen minutes, without the distinctive flavor and/or texture frequently associated with potatoes “baked” in the microwave. In the past, the perfect baked potato could only be prepared in the conventional oven. The conventional oven requires one hour of pre planning and preparation, the use of one hour of electricity, and the bother of heating up the kitchen, particularly in hot weather.

### CROSS REFERENCE TO RELATED APPLICATIONS

Not Applicable

### STATEMENT REGARDING FEDERALLY SPONSERED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF INVENTION

This invention pertains to the technical field of Home Economics. This invention addresses the problems of cooking potatoes in the microwave; specifically, a particular flavor and/or texture not associated with cooking potatoes in a conventional oven.

### BRIEF SUMMARY OF THE INVENTION

Use of the Idaho Spud Sack creates a “just right” baked potato in your microwave. The inside of the potato is well done, yet moist, while the skin remains tender. The potatoes will not have the distinctive flavor and/or texture frequently associated with potatoes cooked in the microwave. The potatoes will have the flavor and texture of potatoes cooked one full hour in your conventional oven. This invention will save the time, power usage, and “heating up the kitchen” normally associated with the preparation of baked potatoes.

### BRIEF DESCRIPTION OF THE SEVERAL VIEWS OF THE DRAWINGS

FIG. 1 shows the ten-inch by forty-five inch segment of one hundred percent cotton Batting, which is the outer “shell” of the Idaho Spud Sack.

FIG. 2 is the ten-inch by twenty-two inch segment of one inch thick polyester batting. This will be the “filler” for the Idaho Spud Sack.

FIG. 3 shows the segment of polyester batting placed on one end of the segment of cotton fabric.

FIG. 4 shows the cotton fabric brought back over the polyester batting to make a “sandwich”, and then serged across the ten inch end.

FIG. 5 shows the fabric folded for the last time, serged on each of the eleven inch sides forming an “envelope” and the loop for hanging attached.

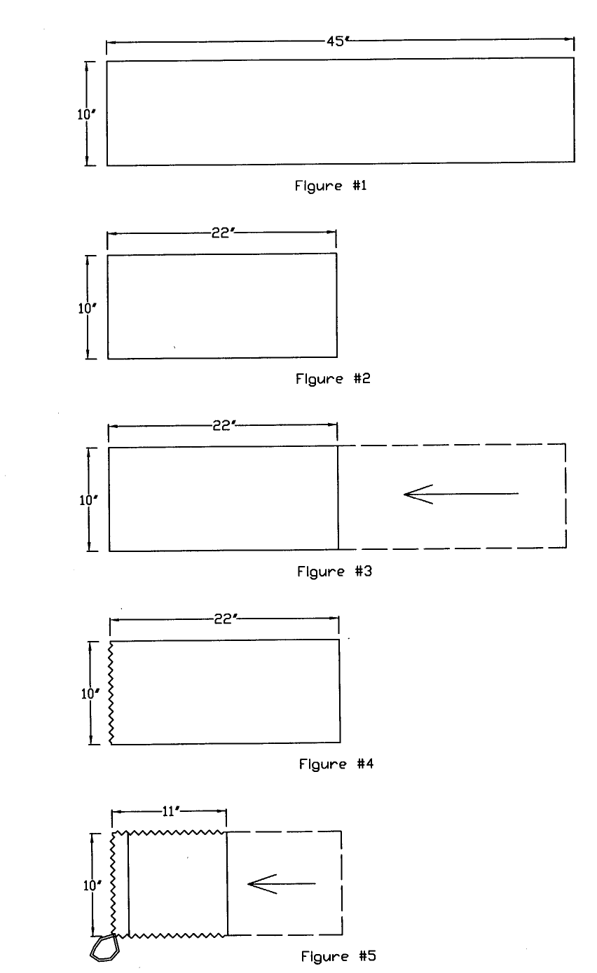

### DETAILED DESCRIPTION OF THE INVENTION

Making the Idaho Spud Sack: The Idaho Spud Sack is made from a segment of one hundred percent cotton fabric that is pre-washed and pressed and a segment of one inch thick polyester batting. The cotton fabric is cut into a rectangle ten inches by forty-five inches. Cut the polyester batting into a ten inch by twenty-two inch rectangle. The cotton fabric is layed flat on the table (finished side down), and over-layed on one end with the ten inch by twenty-two inch segment of one inch thick polyester batting. Both materials can be purchased in most fabric stores. The cotton fabric is then brought back over the batting and sewn on the end measuring ten inches, using a serger type sewing machine. This will create a “sandwich appearance” to the item. The rectangle is again folded creating an “envelope” of fabric measuring ten inches by eleven inches. The fabric bag is then sewn with the serger on each eleven-inch side. A fabric loop made from a one and a half by four inch piece of the cotton fabric is “serged: into one of the eleven inch seams, This loop will be used for hanging the Idaho Spud Sack between usages. The Idaho Spud Sack is now ready for use.

Using the Idaho Spud Sack: The Idaho Spud Sack is large enough to cook two large baking potatoes or four regular size potatoes. Potatoes should be scrubbed thoroughly, but the skin should not be cut in any manner. After drying the potatoes, they should each be wrapped in a dry paper towel and placed into the Idaho Spud Sack. After placing the potatoes into the Idaho Spud Sack, place the Idaho Spud Sack directly onto the microwave turntable. Depending upon the number of potatoes being cooked and the heat of the microwave (Some microwave ovens cook hotter than others.), cook the potatoes from ten to fifteen minutes. At the end of the cooking time, remove the Idaho Spud Sack from the microwave and unwrap each potato. Do not cut the potatoes open with a knife. Simply break the potatoes open with a fork. They will be light and fluffy, just as if you had cooked them in the conventional oven for one hour. There will be no flavor and/or texture, typically associated with microwave potatoes.

1. What I claim as my invention is entitled the Idaho Spud Sack. It is a polyester filled, one hundred percent cotton bag, specifically designed for the purpose of baking potatoes in the microwave oven.
